(19) United States
(12) Patent Application Publication
(10) Pub. No.: US 2015/0370067 A1
(43) Pub. Date: Dec. 24, 2015

(54) Devices and Systems For Real-Time Experience Sharing

(71) Applicant: Filtrest, LLC, Chester Springs, PA (US)

(72) Inventors: Praneeth Denduluri, Chester Springs, PA (US); Karthik Musunuri, Chester Springs, PA (US)

(21) Appl. No.: 14/744,712

(22) Filed: Jun. 19, 2015

Related U.S. Application Data
(60) Provisional application No. 62/014,805, filed on Jun. 20, 2014.

(51) Int. Cl. G02B 27/01

(52) U.S. Cl. CPC G02B 27/0101; G02B 27/017; G02B 2027/013; G02B 2027/0134; G02B 2027/0138; G02B 2027/0178

(57) ABSTRACT

One aspect of the invention provides a device including: a headset defining a bay positioned to cover and enclose the wearer's eyes and obscure the wearer's field of view; one or more screens mounted within the bay; a pair of digital cameras mounted to the headset for capturing video images outside the bay, said pair of digital cameras positioned in a spaced relationship corresponding to a spaced relationship of human eyes; a viewed image display circuit programmed to display a first video signal captured by a first one of said pair of digital cameras and a second video signal captured by a second one of said pair of digital cameras on said one or more display screens to provide a stereographic viewing experience to a wearer; and a transmitter programmed to transmit the first and second video signals to a remote video-sharing device.

### CROSS-REFERENCE TO RELATED APPLICATION

This application claims priority to U.S. Provisional Patent Application Ser. No. 62/014,805, filed Jun. 20, 2014. The entire content of each of this application is hereby incorporated herein by reference.

### BACKGROUND OF THE INVENTION

Although various devices have been proposed for providing immersive virtual reality experiences, none truly replicate the experience of another individual.

### SUMMARY OF THE INVENTION

One aspect of the invention provides a device including: a headset adapted and configured for removable mounting on a wearer's head, the headset defining a bay positioned to cover and enclose the wearer's eyes and obscure the wearer's field of view; one or more screens mounted within the bay; a pair of digital cameras mounted to the headset for capturing video images outside the bay, said pair of digital cameras positioned in a spaced relationship corresponding to a spaced relationship of human eyes; a viewed image display circuit programmed to display a first video signal captured by a first one of said pair of digital cameras and a second video signal captured by a second one of said pair of digital cameras on said one or more display screens to provide a stereographic viewing experience to a wearer of the headset; and a transmitter programmed to transmit the first and second video signals to a remote video-sharing device.

This aspect of the invention can have a variety of embodiments. The one or more display screens can be curved.

The device can include a pair of display screens. The viewed image display circuit can be further programmed to: display a first video signal captured by a first one of said pair of digital cameras on a first of said pair of display screens; and display a second video signal captured by a second one of said pair of digital cameras on a second of said pair of display screens. Each of the pair of digital cameras can be aligned with a corresponding one of the pair of display screens.

The transmitter can be a wireless transmitter. The device can further include a user interface adapted and configured to receive instructions from the wearer to begin, pause, or terminate capture, display, or transmission of video.

The device can include a plurality of audio speakers arranged in proximity to the wearer's ears. The device can include one or more microphones.

Another aspect of the invention provides a device including: a headset adapted and configured for removable mounting on a wearer's head, the headset defining a bay positioned to cover and enclose the wearer's eyes and obscure the wearer's field of view; one or more display screens mounted within the bay; a receiver configured to receive first and second video signals from a remote video-sharing device; and a shared image display circuit programmed to display the first video signal and the second video signal on said one or more display screens to provide a stereographic viewing experience to a wearer of the headset.

This aspect of the invention can have a variety of embodiments. The one or more display screens can be curved.

The device can include a pair of display screens. The shared image display circuit can be further programmed to: display the first video signal on a first one of said pair of display screens; and display the second video signal on a second one of said pair of display screens.

The device can include a plurality of audio speakers arranged in proximity to the wearer's ears.

Another aspect of the invention provides a system including a first device and a second device. The first device includes: a headset adapted and configured for removable mounting on a wearer's head, the headset defining a bay positioned to cover and enclose the wearer's eyes and obscure the wearer's field of view; one or more display screens mounted within the bay; a pair of digital cameras mounted to the headset for capturing video images outside the bay, said pair of digital cameras positioned in a spaced relationship corresponding to a spaced relationship of human eyes; a viewed image display circuit programmed to display a first video signal captured by a first one of said pair of digital cameras and a second video signal captured by a second one of said pair of digital cameras on said one or more display screens; and a transmitter programmed to transmit the first and second video signals. The second device includes: a headset adapted and configured for removable mounting on a wearer's head, the headset defining a bay positioned to cover and enclose the wearer's eyes and obscure the wearer's field of view; one or more display screens mounted within the bay; a receiver configured to receive first and second video signals from the first device; and a shared image display circuit programmed to display the first video signal and the second video signal on said one or more display screens to provide a stereographic viewing experience to a wearer of the headset.

### BRIEF DESCRIPTION OF THE DRAWINGS

For a fuller understanding of the present invention, reference is made to the following detailed description taken in conjunction with the accompanying drawing figures wherein like reference characters denote corresponding parts throughout the several views.

FIG. 1A depicts a top cross-sectional view of a device according to an embodiment of the invention.

FIG. 1B depicts a perspective view of a device according to an embodiment of the invention.

FIG. 2 depicts a system according to an embodiment of the invention.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

Headset devices in accordance with the present invention can be used to share a first user's visual experience with a second, remotely located, user. An exemplary headset includes a pair of digital cameras mounted on a headset in a spaced relationship corresponding to a spaced relationship of human eyes. As the wearer wears the headset, the cameras capture video input, and create corresponding video signals—one corresponding to a wearer's left eye, the other corresponding to the wearer's right eye.

The headset further defines a bay positioned to cover and enclose the wearer's eyes and obscure the wearer's field of view. A pair of display screens are mounted within the bay in a spaced relationship corresponding to a spaced relationship of human eyes—one corresponding to a wearer's left eye, the other corresponding to the wearer's right eye. Preferably, each display screen is a high resolution display, such as a 1920×1080 HD display.

The video signal captured by the left camera is displayed on the left display. The video signal captured by the right camera is displayed on the right display. The dual displays from the dual spaced cameras provide a 3-D visual effect due to stereographic imaging of a field of view. Accordingly, the wearer can wear the headset and have a view of his surroundings similar to a view obtained from the unaided eyes. This display of a viewed image at the wearer's headset is enabled by a viewed image display circuit.

The headset further includes a transmitter configured to transmit the first and second video signals to a remote video-sharing device. More specifically, the headset may include transmitter circuitry for “pairing” with a BLUETOOTH® or other short range wireless transmission transceiver of a conventional smartphone, such as an APPLE® IPHONE® smartphone. Once paired, the headset may transmit the video signals to the smartphone which in turn may communicate them via cellular communications or an IEEE 802.11 or WI-FI® network using conventional smartphone communications technologies that are beyond the scope of the present invention. In some embodiments, video is transmitted between the headset and the smartphone using the IEEE 802.11/WI-FI® standard while commands between the smartphone and the headset are sent using the BLUETOOTH® Low Energy standard. The communication of such video signals, e.g., as video streams, can be managed by an appropriate-configured software application (“app”) executing on the smartphone device.

A second exemplary headset can be provided that is similar to the first headset described above. The second headset is intended for remote viewing of video signals transmitted from the first headset, so that a second, remotely located, person can share in the visual experience of the wearer of the first headset.

The second headset defines a respective bay positioned to cover and enclose the wearer's eyes and obscure the wearer's field of view. Further, the second headset can include a pair of display screens mounted within the bay in a spaced relationship corresponding to a spaced relationship of human eyes—one corresponding to a wearer's left eye, the other corresponding to the wearer's right eye. Preferably, each display screen is a high resolution display, such as a 1920×1080 HD display.

The second headset further includes a receiver configured to receive the first and second video signals from the first headset. More specifically, the headset may include transceiver circuitry for “pairing” with a BLUETOOTH® or other short range wireless transmission transceiver of a conventional smartphone, such as an APPLE® IPHONE® smartphone. Once paired, the headset may receive video signals transmitted to the smartphone via cellular communications or an IEEE 802.11 or WI-FI® network using conventional smartphone communications technologies that are beyond the scope of the present invention. The communication of such video signals, e.g., as video streams, can be managed by an appropriate-configured software application (“app”) executing on the smartphone device.

The second headset includes a shared image display circuit that displays the “left” video signal on the “left” display screen, and the “right” video signal on the “right” display screen, to provide a stereographic viewing experience to a wearer of the headset. More specifically, the viewing experience provided to the second wearer is the video signal captured by the first wearer, and thus the first and second wearers have essentially identical visual experiences, even though they may be located remotely from one another.

Optionally, the first headset may include a microphone for capturing an audio signal, and the second headset may include speakers for reproducing the captured audio signal. In this embodiment, the audio signals can be handled in a manner similar to the video signals.

In one embodiment, the first headset is distinct from the second headset, so that the first headset is constructed specifically as the “sending” device, and the second headset is constructed specifically as the “receiving” device. In another embodiment, the first and second headsets include identical components that includes all components necessary for being either the sending or the receiving device, so that a single headset can function as either a sending or a receiving device.

Accordingly, the headset devices can be used to connect to an app on the smartphone, which will display live streams from friends and from people around the world.

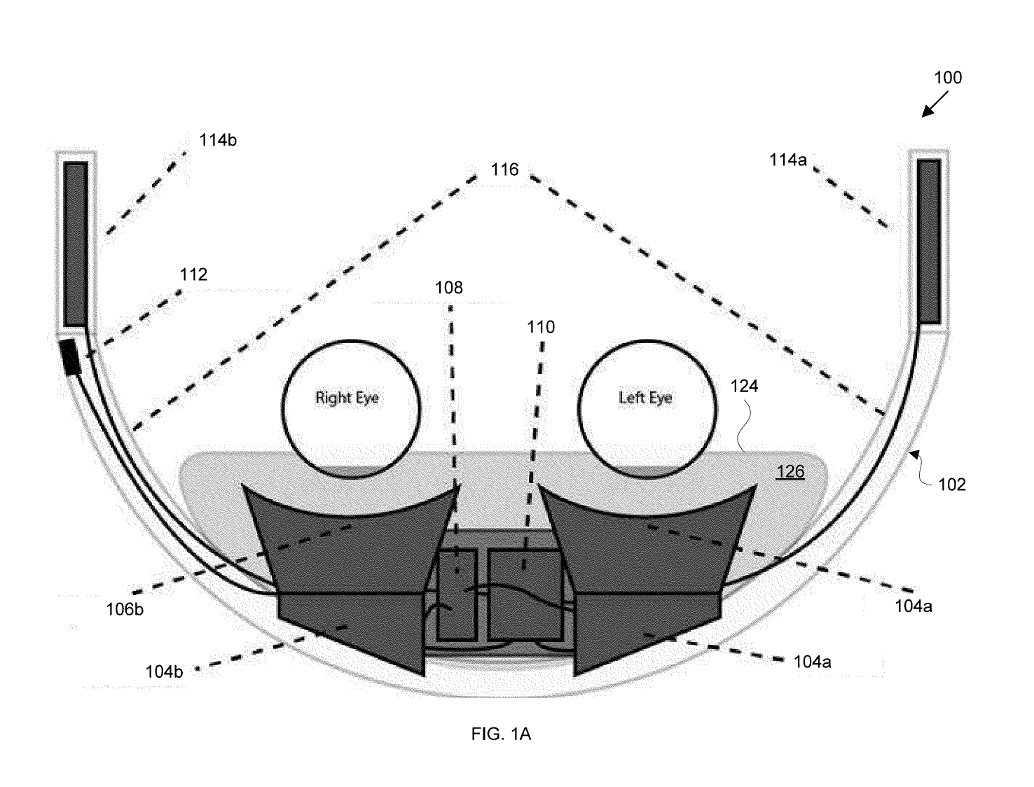

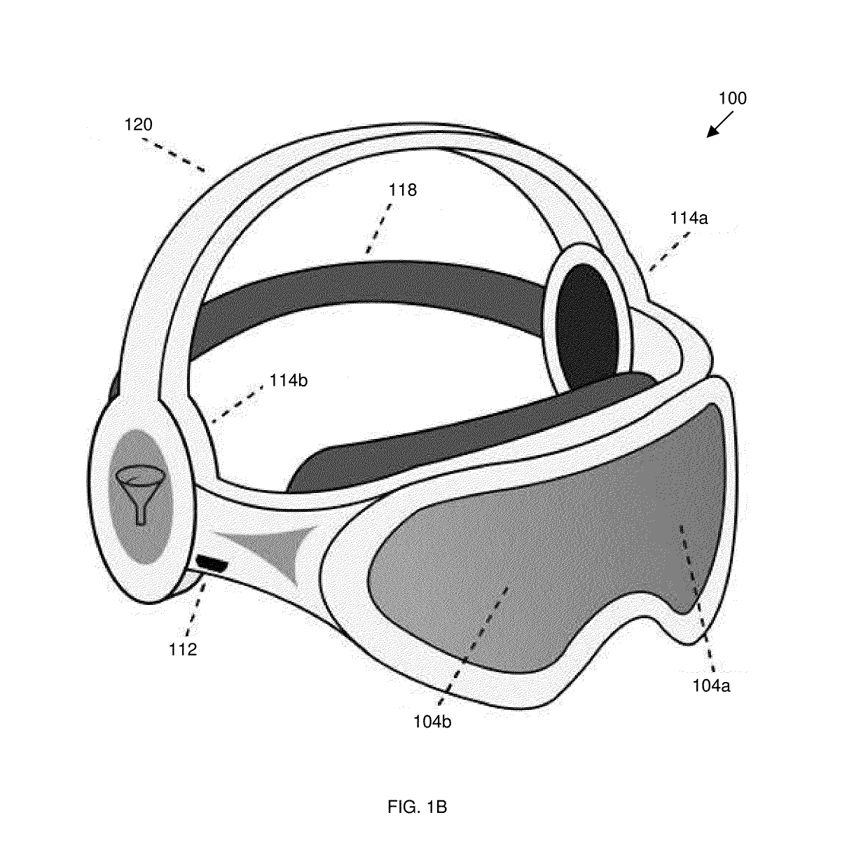

Referring now FIG. 1, a top cross-sectional view of a device 100 is depicted. The device 100 includes a headset 102 adapted and configured for removable mounting relative to a user's head. The headset 102 be of an eyeglasses style in which a temple piece sits behind each of the user's ears and a bridge rests on the subject's nose. In other embodiments, a strap, band, or other device can extend around the back of the user's head to hold the device 100 in position. In still another embodiment, the headset 102 can be mounted (e.g., rotatably) to another piece of headwear such as a helmet). Such an embodiment can be particularly useful for training and monitoring of users such as soldiers or fighter pilots.

Headset 102 can include padding 124 or other material that blocks ambient light from entering into a central box 126 in order to improve the immersive virtual reality experience.

A left camera 104a and a right camera 104b are mounted on the headset 102, preferably substantially in line with the user's eyes. The cameras 104a, 104b can be high-definition (“HD”) cameras, e.g., cameras that are individually capable of capturing video at 960×1080 resolution (full 1920×1080 HD vision in combination). The cameras 104 can be stereoscopic cameras in which one camera 104 captures content in 2D and the other camera 104 captures depth information. Cameras 104 and/or processor can include autofocus technology.

One or more screens (e.g., a single screen spanning across both eyes or a left screen 106a and a right screen 106b) are also mounted on the headset 102. Left screen 106a and right screen 106b are preferably mounted in line with the corresponding cameras 104a, 104b so that the center of the screens 106a, 106b substantially approximate the location of the corresponding cameras 104a, 104b. Additionally or alternatively, the cameras 104a, 104b and/or the center of the screens 106a, 106b can be arranged so that cameras substantially aligned with the wearer's eyes when the wearer holds her head upright and looks straight ahead.

The screens 106a, 106b can be high-definition (“HD”) color screens, e.g., screens that are individually capable of displaying video at 960×1080 resolution (full 1920×1080 HD vision in combination). The screens 106a, 106b can be curved (e.g., to follow a general profile of the human face or ski goggles) in order to provide an immersive virtual reality experience involving the user's peripheral vision (e.g., providing a field of view of at least 140°, 150°, 160°, 170°, 180°, and the like). In some embodiments, the screen(s) 106 are Active Matrix OLED (AMOLED) screens. Screens 106a, 106b can be directly coupled to receive video from corresponding camera 104a, 104b or can be coupled to a processor that can be programmed to receive and/or distribute video from and/or to appropriate cameras 104 and/or a transmitter/receiver/transceiver 108.

The cameras 104 and screens 106 can preferably capture and display video at a rate of at least 30 Hz or at least 60 Hz.

The processor can be an integrated circuit or system on chip (SOC) such as the SNAPDRAGON® platform available from QUALCOMM Incorporated of San Diego, Calif.). In one embodiment, the processor includes dual 1080P parallel stream captures and dual 1080P display pipelines. The processor can perform various video encoding and/or compression algorithms to minimize the size of video to be stored and/or transmitted.

In one embodiment, the video latency from capture by cameras 104 to display on screen(s) 106 is 1 frame or less or less than about 200 ms, less than about 150 ms, less than about 100 ms, less than about 50 ms, less than about 25 ms, less than about 10 ms, less than about 5 ms, and the like.

In some embodiments, the cameras 104 and screens 106 are adjustable within the headset 102 to optimally fit the relative positions of a user's eyes.

Transmitter/receiver/transceiver 108 can be any device capable of communicating video and/or other information to another device. Transmitter/receiver/transceiver 108 can be wired or wireless.

For example, the transmitter/receiver/transceiver 108 can include the appropriate hardware and/or software to implement one or more of the following communication protocols: Universal Serial Bus (USB), USB 2.0, USB 3.0, IEEE 1394, Peripheral Component Interconnect (PCI), Ethernet, Gigabit Ethernet, and the like. The USB and USB 2.0 standards are described in publications such as Andrew S. Tanenbaum, Structured Computer Organization Section §3.6.4 (5th ed. 2006); and Andrew S. Tanenbaum, Modern Operating Systems 32 (2d ed. 2001). The IEEE 1394 standard is described in Andrew S. Tanenbaum, Modern Operating Systems 32 (2d ed. 2001). The PCI standard is described in Andrew S. Tanenbaum, Modern Operating Systems 31 (2d ed. 2001); Andrew S. Tanenbaum, Structured Computer Organization 91, 183-89 (4th ed. 1999). The Ethernet and Gigabit Ethernet standards are discussed in Andrew S. Tanenbaum, Computer Networks 17, 65-68, 271-92 (4th ed. 2003).

In other embodiments, the transmitter/receiver/transceiver 108 can include appropriate hardware and/or software to implement one or more of the following communication protocols: BLUETOOTH®, IEEE 802.11, IEEE 802.15.4, and the like. The BLUETOOTH® standard is discussed in Andrew S. Tanenbaum, Computer Networks 21, 310-17 (4th ed. 2003). The IEEE 802.11 standard is discussed in Andrew S. Tanenbaum, Computer Networks 292-302 (4th ed. 2003). The IEEE 802.15.4 standard is described in Yu-Kai Huang & Ai-Chan Pang, “A Comprehensive Study of Low-Power Operation in IEEE 802.15.4” in MSWiM'07 405-08 (2007).

In still another embodiment, the transmitter/receiver/transceiver 108 implements a mobile telecommunications protocol such as 3G, 4G LTE, 5G, and the like.

Device 100 can also include a power source 110. The power source 110 can receive, store, and/or provide alternating or direct current. In some embodiments, the power source is a battery, e.g., a rechargeable battery. Rechargeable batteries are available in a variety of chemistries including nickel cadmium (NiCd), nickel metal hydride (NiMH), lithium ion (Li-ion), and lithium ion polymer (Li-ion polymer)

Device 100 can include one or more ports 112 that can be utilized for wired communication and/or power transfer. For example, port 112 can be a USB, mini USB, or micro USB port. Port 112 can be communicatively coupled directly or indirectly to other components such as the power source 110.

One or more speaker 114a, 114b can also be mounted on frame 100 to play sound in the user's ears. Speakers 114a, 114b can be coupled to transmitter/receiver/transceiver 108 or a processor wirelessly or through wires 116. Speakers 114a, 114b can provide 44,000 Hz 7.1 channel surround sound. Speakers 114 can implement various audio protocols technologies such as binaural sound, stereo sound, Virtual Surround Sound 7.1, those specified by DTS, Inc. of Calabasas, Calif., and the like.

Device 100 can also include one or more microphones to capture sound for transmission to the user and/or another user. In one embodiment, a plurality of microphones are provided, each corresponding to a particular speaker 114 on the device 100

Referring now to FIG. 1B, a perspective view of device 100 is provided in which back strap 118 and overhead strap 120 can be more cleanly seen.

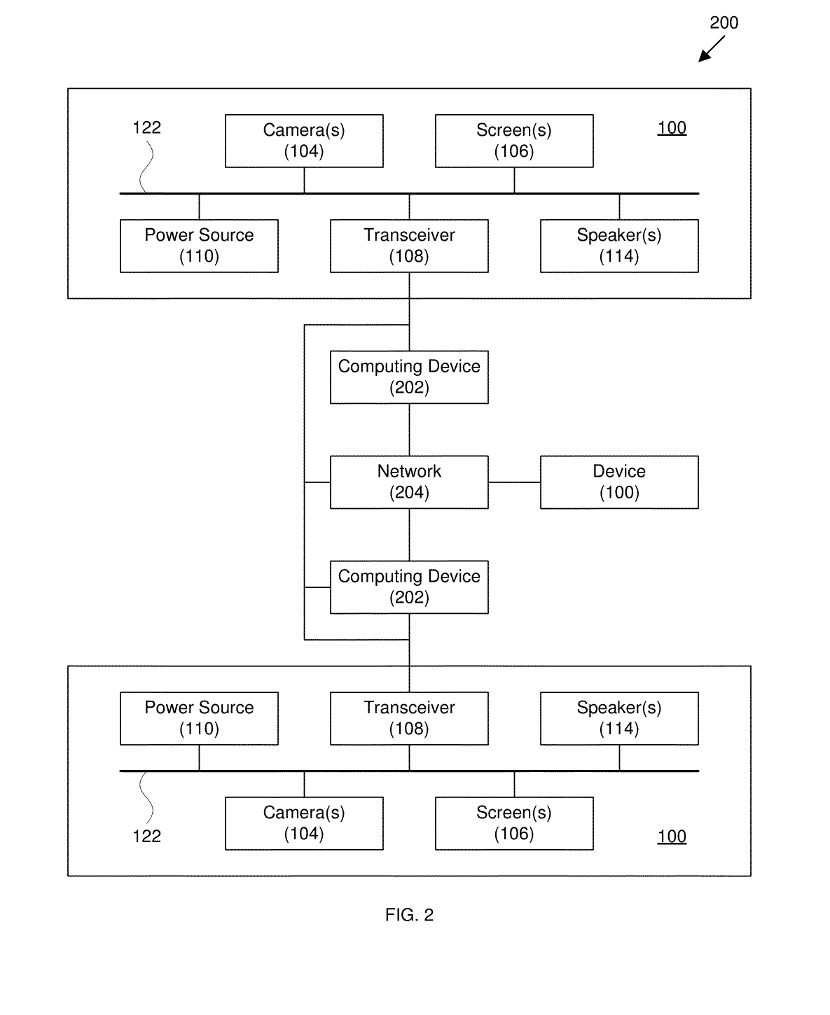

Referring to FIG. 2, an embodiment of a system 200 including one or more devices 100 is depicted. Devices 100 can be communicatively coupled to other devices via one or more computing devices 202 and/or a network 204 such as the Internet. Computing devices 202 can include smartphones (e.g., a device sold under the IPHONE® trademark by Apple, Inc. of Cupertino, Calif., the WINDOWS® trademark by Microsoft Corporation of Redmond Wash., the ANDROID™ trademark by Google Inc. of Mountain View, Calif., and the like), a tablet (e.g., devices sold under the IPAD® trademark from Apple Inc. of Cupertino, Calif. and the KINDLE® trademark from Amazon Technologies, LLC of Reno, Nev. and devices that utilize WINDOWS® operating systems available from Microsoft Corporation of Redmond, Wash. or ANDROID® operating systems available from Google Inc. of Mountain View, Calif.), a personal computer, a video game console (e.g., the WII U® console available from Nintendo of America Inc. of Redmond, Wash.; the SONY® PLAYSTATION™ console available from Kabushiki Kaisha Sony Corporation of Tokyo, Japan; the MICROSOFT® XBOX™ console available from Microsoft Corporation of Redmond, Wash.), and the like.

Components 104, 106, 110, and 114 can be coupled to transceiver 108 via a bus 122.

One or more user interfaces can be provided either on the device 100 or the computing device 202. User interfaces can be implemented in hardware and/or software. For example, device 100 can include one or more physical buttons that allow the user to shift between a recorder mode and a receiver mode, begin or pause capturing video, mute or unmute the microphone(s), adjust volume, pause, begin, advance, rewind, or mute recorded video, and the like. For example, a user can press a “record” button to record video and hold the “record” button to live-stream video. An application (or “app”) on computing device can allow the user to control further aspects of the invention such as to whom video is transmitted, what the video should be named or tagged, and the like. In one embodiment, the user can use the app to invite other users to view the video either in real-time or after recording.

Video from a device 100 in recording mode can be stored locally on the device 100, on a connected computing device 202, and/or on a remote storage device (e.g., a cloud-based storage service). Additionally or alternatively, video from device 100 can be uploaded to a video sharing service (e.g., YOUTUBE®). In some embodiments, the video sharing service will focus on or provide categories focused on immersive videos captures using embodiments of the invention. In still another embodiment, the video can be transmitted directly to one or more devices 100 in the receiver mode using various standards for communications between two or more networked devices.

Embodiments of the invention can be applied to a variety of applications. For example, device 100 can be worn by medical professionals (e.g., surgeons) and other professionals to provide a view of a procedure from the professional's perspective. Device 100 can also be worn by consumers to capture and/or share an immersive experience with others while traveling.

### EQUIVALENTS

The functions of several elements may, in alternative embodiments, be carried out by fewer elements, or a single element. Similarly, in some embodiments, any functional element may perform fewer, or different, operations than those described with respect to the illustrated embodiment.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

### INCORPORATION BY REFERENCE

The entire contents of all patents, published patent applications, and other references cited herein are hereby expressly incorporated herein in their entireties by reference.

1. A device comprising:
a headset adapted and configured for removable mounting on a wearer's head, the headset defining a bay positioned to cover and enclose the wearer's eyes and obscure the wearer's field of view;
one or more screens mounted within the bay;
a pair of digital cameras mounted to the headset for capturing video images outside the bay, said pair of digital cameras positioned in a spaced relationship corresponding to a spaced relationship of human eyes;
a viewed image display circuit programmed to display a first video signal captured by a first one of said pair of digital cameras and a second video signal captured by a second one of said pair of digital cameras on said one or more display screens to provide a stereographic viewing experience to a wearer of the headset; and
a transmitter programmed to transmit the first and second video signals to a remote video-sharing device.

2. The device of claim 1, wherein the one or more display screens are curved.

3. The device of claim 1, wherein the device comprises a pair of display screens.

4. The device of claim 3, wherein the viewed image display circuit is further programmed to:
display a first video signal captured by a first one of said pair of digital cameras on a first of said pair of display screens; and
display a second video signal captured by a second one of said pair of digital cameras on a second of said pair of display screens.

5. The device of claim 3, wherein each of the pair of digital cameras is aligned with a corresponding one of the pair of display screens.

6. The device of claim 1, wherein the transmitter is a wireless transmitter.

7. The device of claim 1, wherein further comprising:
a user interface adapted and configured to receive instructions from the wearer to begin, pause, or terminate capture, display, or transmission of video.

8. The device of claim 1, further comprising:
a plurality of audio speakers arranged in proximity to the wearer's ears.

9. The device of claim 1, further comprising:
one or more microphones.

10. A device comprising:
a headset adapted and configured for removable mounting on a wearer's head, the headset defining a bay positioned to cover and enclose the wearer's eyes and obscure the wearer's field of view;
one or more display screens mounted within the bay;
a receiver configured to receive first and second video signals from a remote video-sharing device; and
a shared image display circuit programmed to display the first video signal and the second video signal on said one or more display screens to provide a stereographic viewing experience to a wearer of the headset.

11. The device of claim 10, wherein the one or more display screens are curved.

12. The device of claim 10, wherein the device comprises a pair of display screens.

13. The device of claim 12, wherein the shared image display circuit is further programmed to:
display the first video signal on a first one of said pair of display screens; and
display the second video signal on a second one of said pair of display screens.

14. The device of claim 10, further comprising:
a plurality of audio speakers arranged in proximity to the wearer's ears.

15. A system comprising:
a first device comprising:
a headset adapted and configured for removable mounting on a wearer's head, the headset defining a bay positioned to cover and enclose the wearer's eyes and obscure the wearer's field of view;
one or more display screens mounted within the bay;
a pair of digital cameras mounted to the headset for capturing video images outside the bay, said pair of digital cameras positioned in a spaced relationship corresponding to a spaced relationship of human eyes;
a viewed image display circuit programmed to display a first video signal captured by a first one of said pair of digital cameras and a second video signal captured by a second one of said pair of digital cameras on said one or more display screens; and
a transmitter programmed to transmit the first and second video signals; and
a second device comprising:
a headset adapted and configured for removable mounting on a wearer's head, the headset defining a bay positioned to cover and enclose the wearer's eyes and obscure the wearer's field of view;
one or more display screens mounted within the bay;
a receiver configured to receive first and second video signals from the first device; and
a shared image display circuit programmed to display the first video signal and the second video signal on said one or more display screens to provide a stereographic viewing experience to a wearer of the headset.
